(19) United States
(12) Patent Application Publication
(10) Pub. No.: US 2006/0076954 A1
(43) Pub. Date: Apr. 13, 2006

(54) Method for compensating for a magnetic field disturbance affecting a magnetic resonance device, and a magnetic resonance device

(75) Inventors: Ralph Kimmlingen, Nurnberg (DE); Axel vom Endt, Erlangen (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignees: Siemens Aktiengesellschaft; Siemens Magnet Technology Ltd.

(21) Appl. No.: 11/244,779

(22) Filed: Oct. 6, 2005

(30) Foreign Application Priority Data
Oct. 11, 2004 (DE) 10 2004 049 497.5

(51) Int. Cl. G01V 3/00

(52) U.S. Cl. 324/320; 324/313; 324/307

(57) ABSTRACT

The invention relates to a method for compensating for a magnetic field disturbance affecting a magnetic resonance device, whereby the magnetic field disturbance is caused by a deflection of a component of the magnetic resonance device. To this end, the deflection or a variable causing the deflection is acquired in timed-dependent fashion, a mathematical field disturbance model is provided which models the effect the of the deflection on the magnetic field, and the acquired deflection or the variable causing the deflection is converted by means of the field disturbance model into a control variable for a compensation magnetic field generator or a high-frequency antenna. The compensation magnetic field generator controlled in this manner generates, for example, a compensation magnetic field which compensates for the magnetic field disturbance. The high-frequency antenna controlled in this manner is, for example, matched in its mid frequency to the magnetic field disturbance.

### CROSS REFERENCE TO RELATED APPLICATIONS

This application claims priority to the German application No. 10 2004 049 497.5, filed Oct. 11, 2004 which is incorporated by reference herein in its entirety.

### FIELD OF INVENTION

The invention relates to a method for compensating for a magnetic field disturbance affecting a magnetic resonance device, whereby the magnetic field disturbance is caused by a deflection of a component of the magnetic resonance device. The invention also relates to a magnetic resonance device having a component which can be spatially deflected and whose deflection causes a disturbance in a magnetic field of the magnetic resonance device.

### BACKGROUND OF INVENTION

Magnetic resonance technology (MR technology) enables medical imaging, for example. In an MR device, an area of a patient to be examined is for example exposed to a high-frequency magnetic field (HF field) in a basic magnetic field in order to excite an emission of MR signals. The MR signals are detected for spatially resolved imaging purposes, whereby a location coding is achieved with the aid of spatially varying gradient magnetic fields. The quality of an MR image depends among other things on the homogeneity of the basic magnetic field. This is normally created using a superconducting basic field magnet. Together with demands on the gradient and HF field, the homogeneity of the basic magnetic field determines a useable imaging area for the MR device. The requirements for the magnetic and HF sending fields, in respect of spatial and timing quality for example, depend in turn on the respective measurement frequency to be implemented. Any vibrations occurring in individual components which generate the fields can result in disturbances in the fields.

### SUMMARY OF INVENTION

One example is the sensitivity to vibration of the basic field magnet: MR devices are also used in environments in which they are exposed to floor vibrations. These floor vibrations can be transferred to the internal structure of the magnet and result in fluctuations in the magnetic field. The deflection of the basic field magnet, or more precisely of the cold shield with respect to the basic magnetic field coil, inevitably results in a change, in other words a disturbance, in the magnetic field in the imaging area. This becomes noticeable as an artifact in the MR image. This problem is exaggerated further by the trend towards smaller, lighter, more simply constructed magnets and relates to both open (planar) and cylindrical MR devices.

Possible approaches for preventing such types of disturbances are based on a passive and/or active mechanical buffering of components sensitive to vibration. For example, the internal structure of the magnet (the suspension of a cold shield, for example) is designed to provide the best possible mechanical buffering from the surroundings. Further known measures are the buffering of the bearing surfaces of the MR device, in other words the floor of the imaging area, by means of special materials (polyurethane plates such as Sylomer or Sylodamp, for example) or compensation for transmitted vibrations by means of piezoactuators.

A method for compensating for disturbances caused by vibrations in the case of MR devices is known from DE 102 21 640 A1, in which a compensation facility is used for correcting magnetic field fluctuations generated by vibrations of a cold head. The compensation facility sets a synthesizer frequency and also gradient currents in accordance with the time characteristic obtained in a tune-up of the field terms of the zeroth and first order.

With regard to method which has become known from US 2001/0013778 A1 for compensating for disturbances caused by vibrations in the case of MR devices, magnetic field correction coils are provided which generate a correction field whose amplitude corresponds to the magnetic field variations that are brought about by the mechanical vibrations which are initiated by the cooling head that is usually operated using helium. This compensation by means of separate correction coils is not only extremely complex in construction, but the square wave pulse control facility provided there also only enables coarse corrections because it only detects when the piston of the cooling head begins a movement stroke in the one or other direction.

A facility for compensating for external field disturbances of the basic magnetic field in the case of MR devices is known from DE 197 02 831 A1. The field disturbances are detected by means of a magnetoresistive sensor on a probe and taken into account during generation of the basic magnetic field or when obtaining a signal or computing a signal.

A gradient coil system is known from U.S. Pat. No. 6,538,443 B2 which has a basic gradient coil and a correction gradient coil. The latter generates selectable gradient fields of a higher order which together with the gradient field of the basic gradient coil can result in volumes of differing magnitudes with linear gradient fields.

An object of the invention is to compensate for a magnetic field disturbance resulting from a deflectable component.

The object is achieved by the claims. The deflection or a variable causing the deflection is acquired, a mathematical field disturbance model is provided which models the effect of the deflection on the magnetic field; the acquired deflection or the variable causing the deflection is converted by means of the field disturbance model into a control variable for a compensation magnetic field generator, such that a compensation magnetic field compensating for the magnetic field disturbance is generated, and/or is converted into a control variable for setting a mid frequency of a high-frequency antenna of the magnetic resonance device, adapted to the magnetic field disturbance.

The method according to the invention has the advantage that, depending on the deflection or the variable causing the deflection, the field disturbance model models a field disturbance caused by this. In this manner, it is possible to compensate for different types of unforeseeable deflections and thus correlating field disturbances by appropriate control of a compensation magnetic field generator.

An advantage of the invention compared with the use of polyurethane sheets lies in its effectiveness also extending into frequency range below 25 Hz. An advantage compared with compensating for the disturbance by means of piezoactuators consists in the fact that no installation of additional active components is required in the basic field magnet, as a result of which the risk of faults during production and operation of the MR device is reduced.

An advantage compared with the method based on tune-up data from DE 102 21 640 A1 lies in the high level of flexibility of the compensation compared with any deflection of the component, in particular also unknown deflection. With the aid of the field disturbance model, one is not restricted to compensating for disturbances which can only be corrected by means of a tune-up.

The object is also achieved by a magnetic resonance device which has a component that can be spatially deflected and whose deflection causes a disturbance in a magnetic field of the magnetic resonance device, and which has means for acquiring the deflection or a variable causing the deflection and also has a control unit, whereby the control unit feeds the acquired deflection or variable causing the deflection to a mathematical field disturbance model which models the effect of the deflection on the magnetic field and which generates a control variable that results in an operation which takes into account the magnetic field disturbance.

To this end, the control variable can for example match the mid frequency of a high-frequency antenna unit to the magnetic field disturbance. In other words, after the matching has been carried out high-frequency signals are received or transmitted at the frequency which are matched to the magnetic field present in the magnetic resonance device as a result of the disturbance. Accordingly, the excitation and reception of MR signals are no longer influenced by the disturbance, or this influence is at least reduced. This can be realized for example by means of a specific modulation of a synthesizer frequency from a synthesizer which serves to control the high-frequency antenna unit. To put it another way, in this manner the effects of changes to the basic magnetic field are compensated for by a change in the measuring frequency.

In addition or as an alternative, the control variable can control a compensation magnetic field generator in such a manner that the latter generates a compensation magnetic field which compensates for the magnetic field disturbance.

With the aid of the invention, magnetic field disturbances or their effect on the MR excitation or MR signal frequency can for example be compensated for in an imaging area of the MR device. To this end, in the mathematical field disturbance model the magnetic field disturbance in the imaging area is calculated and balanced with an adjustable compensation magnetic field.

The compensation by means of compensation magnetic fields can also be directed at conducting surfaces in order to suppress additional eddy currents there.

In a special embodiment the component is a cold shield of a basic field magnet of the magnetic resonance device, whereby the cold shield is deflected in particular as a result of a floor vibration with respect to a basic magnetic field coil of the basic field magnet. As a result of the deflection, currents are induced in the cold shield which for their part result in magnetic field disturbances, for example in the imaging area. According to the invention, compensation magnetic fields are generated which compensate for these magnetic field disturbances. To this end, the mathematical field disturbance model calculates the induced currents on the cold shield from the time-dependent deflection, which in its turn can be calculated from the variable causing the deflection. By means of the currents it is now possible for example to calculate field disturbances in the imaging area on a model basis. These are balanced with the field characteristic of the compensation magnetic field generator and the control variable is determined such that the compensation magnetic field counteracts the magnetic field disturbance in the best possible manner. The basic field magnet, a gradient coil and/or a shim coil of a higher order for example can be used as the compensation magnetic field generator. Alternatively, it is possible to use specifically designed field coils, such as are described for example in the prior art cited at the beginning.

For performing time-dependent measurement of the deflection, it is possible for example to use at least a strain gage and/or an accelerometer which are located for example on a suspension element of the component. The accelerometer can alternatively vibrations [sic] be disposed at the contact points between the MR device and the floor or a source of vibration. In addition to the time-dependent deflection, it is also possible in this manner to measure an oscillation not directly associated with the component. One example of such a variable effecting the deflection is the floor vibration mentioned above.

By preference, the field disturbance model comprises a mechanical model of the MR device. By using this, a conclusion concerning the motion of the component can be drawn from an acquired time-dependent deflection or from a variable effecting the deflection, and the calculation of the magnetic field disturbance can be performed. To this end, a mechanical fixing for the component in the magnetic resonance device and/or the mass of the component for example are taken into consideration in the mechanical model. A comprehensive mechanical model additionally describes the different fixings of all units of the MR device determining the motion behavior of the component and takes their masses into consideration when modeling the deflection of the component.

Furthermore, the field disturbance model comprises for example a physical calculation model based on the Maxwell equations. By using this, the magnetic field disturbances induced in the basic magnetic field through the motion of the component, for example, can be calculated and projected onto the compensation magnetic fields which can be generated in order to obtain the corresponding parameters (control variables) for the compensating operation of at least one compensation magnetic field generator.

Further advantageous embodiments of the invention are characterized by the features of the dependent claims.

### BRIEF DESCRIPTION OF THE DRAWINGS

Several embodiments of the invention are described in the following with reference to FIGS. 1 to 6. In the drawings:

FIG. 1 shows a block diagram illustrating by way of example the sequence of the method,

FIG. 2 shows a section through an MR device with an example of an implementation of the invention, FIG. 3 shows an enlarged section to illustrate the use of strain gages,

FIG. 4 shows a simplified mechanical rigid body model of the basic field magnet of the magnetic resonance device from FIG. 2,

FIG. 5 shows a schematic representation of the current induced on the cold shield and

FIG. 6 shows a block diagram by way of example for the purpose of magnetic field compensation using the magnetic resonance device from FIG. 2.

### DETAILED DESCRIPTION OF INVENTION

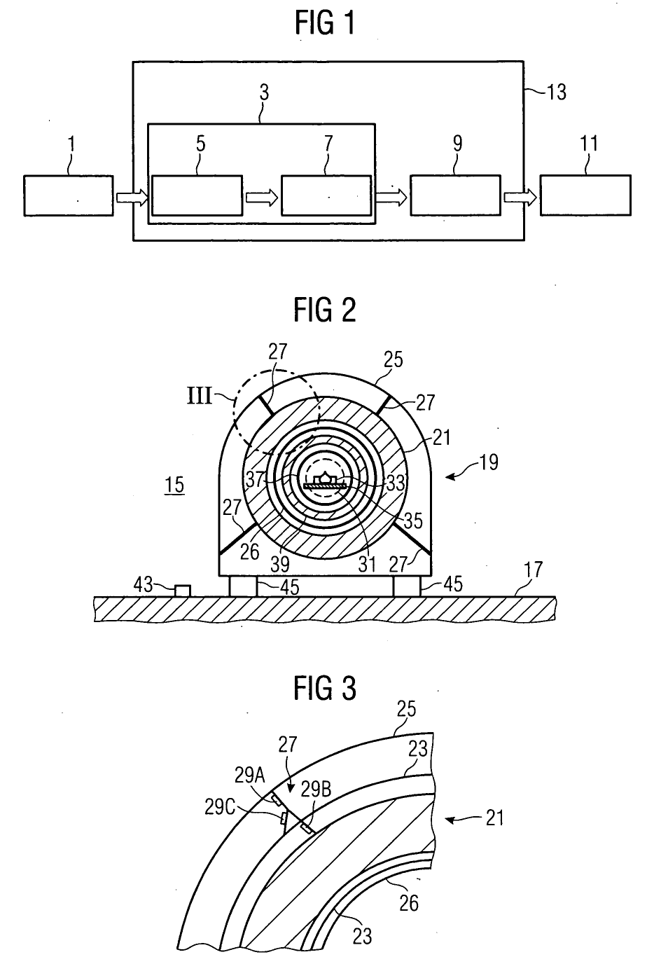

FIG. 1 shows a block diagram illustrating by way of example the sequence of the method according to the invention. A floor vibration leads for example to a deflection 1 of a component of the MR device, as a result of which a magnetic field disturbance is generated which must be compensated for.

In a first step, the time-dependent deflection 1 of the component, the cold shield for example, is measured with the aid of strain gages or accelerometer sensors. The deflection 1 is processed in a field disturbance model 3 in order to calculate a control variable.

To this end it is fed into a mechanical model 5 which describes a mechanical structure of the MR device through variables such as spring and damping constants of connections between units of the MR device and the masses of the units in a type of motion equation. The deflection can be measured either directly or indirectly, with the result that mechanical models 5 developed to different levels can be used in the field disturbance model 3. The crucial point is that it should be possible in the mechanical model 5 to at least approximately calculate the motion of the component, for example in the basic magnetic field.

A magnetic field disturbance calculation 7 is performed in the field disturbance model 3 by means of the motion equations and the magnetic field of the MR device acting on the component. In other words, the disturbance of the magnetic field in an imaging area of the MR device which is generated by the eddy currents induced as a result of the motion of the component in the basic magnetic field is calculated, for example. The equation for the “stream function” is solved in order to perform the magnetic field disturbance calculation 7:

$$Δ C = - \frac{\partial H}{\partial t}$$

From this results the current density through: j=σ∇×C. This induced current in the form of eddy currents generates the magnetic field disturbances which can be described for example by way of a spherical function expansion:

$$B ( r , Θ , Φ ) = {\sum }_{l = 0}^{∞} {\sum }_{m = - 1}^{+ l} A ( l , m ) \cdot {r}^{l} \cdot {Y}_{lm} ( Θ , Φ )$$

A balancing 9 with the spherical function expansion of the generatable compensation magnetic field of one or more compensation magnetic field generators 11 enables the calculation of the compensation currents which are to be set. Magnetic field generators used in the MR device are preferably employed as compensation magnetic field generators 11, for example the basic magnetic field coil, one or more gradient coils or shim coils of a higher order. Alternatively, it is also possible to specifically provide compensation magnetic field generators in the magnetic resonance device. If the compensation currents are fed to the corresponding field coils, these generate the compensation magnetic fields compensating for the magnetic field disturbances.

To summarize, it can be said that the measurement values from an accelerometer are converted by way of strain gages and using the mechanical model 5 into an incidental amplitude which excites the cold shield of the basic field magnet to produce a harmonic oscillation. With the aid of the field disturbance model 3, the coefficients of the spherical function expansion of the resulting magnetic field disturbance are also ascertained. For each relevant order of expansion of the magnetic field disturbance, the field disturbance model 3 calculates a correctly phased current/time function which is superposed on the currents of the field coils.

Instead of the balancing 9, a new mid frequency matched to the field disturbance can be calculated for receiving and/or sending MR signals. This is used for example with the help of the control variable and a synthesizer controlling a high—frequency antenna for the purpose of MR measurement. In this situation, both a whole-body high-frequency antenna and also a local antenna located close to a body region can be selected.

FIG. 2 shows a section through an MR device 15 which is mounted on a floor 17. Oscillations from the floor 17 can be transmitted to a basic field magnet 19. In the central imaging area, for example in a volume suitable for spectral fat saturation and having a diameter of 0.2 m, the deviation from a constant basic magnetic field is typically less than 0.1 ppm. At a field intensity of 1.5 T this corresponds to a magnetic field incidental amplitude in the order of 0.1 μT, whereby the precise value depends on the standardization convention used and on the order of expansion of the field disturbance. Field disturbances resulting from floor vibrations lie in the same order of magnitude and can therefore have a negative influence on sensitive MR examinations.

The basic field magnet 19 comprises for example a basic magnetic field coil 21, a cold shield 23 and a vacuum sleeve 25,26. These are represented schematically in FIG. 3. The basic magnetic field coil 21 and the cold shield 23 are suspended separately on the outer vacuum sleeve 25 using a plurality of suspension mountings 27. These are indicated by way of example in FIG. 2 at four positions in the sectional plane. Four further suspension mountings are normally located in a further sectional plane.

At least one of the suspension mountings 27 has one or more strain gages 29A, 29B, 29C for measuring the deflection. Refer in this context to the enlarged part-section shown in FIG. 3. The use of strain gages 29A, 29B, 29C can be limited to a single suspension point in the case of a correspondingly detailed mechanical model.

The imaging area 31 into which a patient 33 can be introduced with the aid of a patient table 35 is situated in the center of the hollow cylindrical shaped basic field magnet 19. From the inside to the outside, an inner lining 37 with a whole-body high-freqency antenna and a gradient coil unit 39 with the gradient coils for the different spatial directions are located between the imaging area 31 and the basic field magnet 19.

As an alternative to using strain gages 29A, 29B, 29C it is possible to use one or more accelerometer sensors 43 in order to detect the floor vibrations in the area of rails 45 carrying the magnetic resonance device. The advantage of strain gages lies in the fact that the amplitudes of the deflection of the component are measured directly and a simple mechanical model can thus be used. The advantage of accelerometer sensors which are fixed to the floor is the fact that they can be retrofitted at any time provided the mechanical model of the basic field magnet is known. This model can be subsequently calibrated and thus be adapted to suit the existing situation in each case.

The electrically conducting and heat-conducting cold shield 23 forms a sleeve around the basic magnetic field coil 21 and screens the latter against external heat radiation. As a result of the separate suspension mounting of the conducting cold shield 23 and the basic magnetic field coil 21 vibrations, such as floor vibrations, can result in a relative motion between basic magnetic field coil 21 and cold shield 23. A relative motion of a conducting surface, here for example of the cold shield 23, in the basic magnetic field of the basic magnetic field coil 21 results in eddy currents. These cause magnetic field disturbances in the imaging area 31 of the MR device 15.

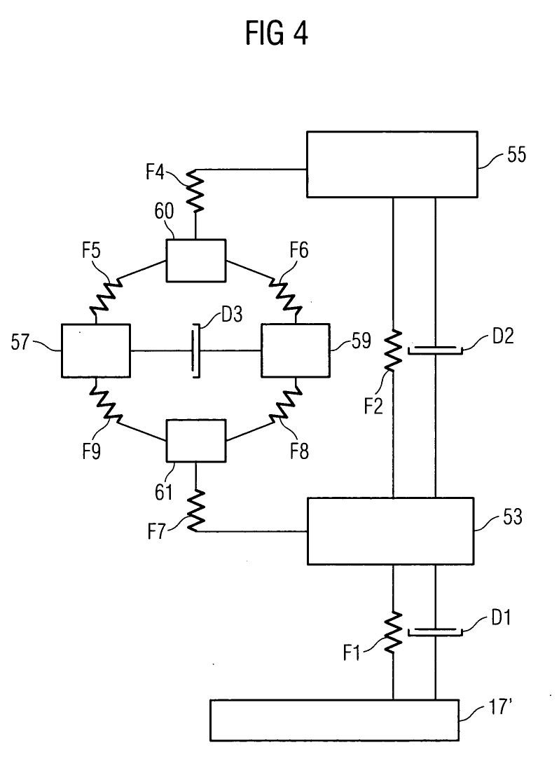

In order to compensate for this magnetic field disturbance, the relative motion is modeled with the aid of the strain gages 29A, . . . 29C and/or the accelerometer sensors 43 and a mechanical model, as is illustrated by way of example in FIG. 4. The relative motion is used as an input variable for the magnetic field disturbance calculation.

The mechanical properties of the basic field magnet 19 are in a simple rigid body model formed from masses, springs and damper elements: \overline{m}\vec{\ddot{x}}+\overline{k}\vec{\dot{x}}+\overline{D}\vec{x}=0, where \overline{m} is the mass matrix, \overline{k} is the mechanical coupling matrix and \overline{D} is the damping matrix. A model of such a type is preferably suited for low frequencies, whereby higher frequency components of the floor vibration spectrum can be decoupled by means of a suitable bearing arrangement for the basic field magnet 19. The masses and spring constants are known from the construction of the basic field magnet 19. In order to determine the damping constants, a sinusoidal deflection x=x₀ sin ωt of the cold shield 23 is assumed.

In FIG. 4 the floor 17′, which is connected to the lower half of the vacuum sleeve 53, can be recognized in the mechanical model. The elastic connection is described by way of the spring constant F1 and the damping constant D1. The upper half 55 of the vacuum sleeve is connected elastically to the lower half 53 of the vacuum sleeve 53 by way of spring constant F2 and damping constant D2. The basic magnetic field coil 57 and cold shield 59 elements suspended in the vacuum sleeve are connected to one an other by way of the damping constant D3. The forked connection with the upper half 55 and the lower half 53 is implemented in each case by way of three springs F4,F5,F6 and F7,F8,F9 respectively and the associated connection parts 60 and 61. If all the variables are given and if the motion of the floor 51 is known from a measurement, the relative motion of cold shield 59 and basic field magnet 57 can be calculated.

If strain gages are used on the springs F4,F5,F6, the mechanical model can be simplified.

Taking a sinusoidal deflection of the cold shield as the basis, the field disturbance model solves the equation for the “stream function”

$$Δ C = - \frac{\partial H}{\partial t} , where$$

$$\frac{\partial H}{\partial t} = \frac{ⅆ H}{ⅆ x} ω cos ω t$$

is the flux change occurring as a result of the motion in the location-dependent field of the basic field magnet. The current density is then given by: j=σ∇×C

An example of a result of the calculation is shown in FIG. 5. In this the induced eddy currents are illustrated by arrows 63 on the schematic representation of a hollow cylindrical shaped cold shield 59′. Current densities running azimuthally can be recognized at the ends of the cold shield 59′. The currents join in the—in the axial direction—central area of the cold shield 59′ with currents of the opposite direction. The current distributions on the inner and outer walls of the cold shield 59′ are similar to one another. It should be stressed that in the case illustrated the current path on the lower and upper halves of the cold shield 59′ is formed in opposite directions, in other words it is mirror symmetric. A current path of this type corresponds to the current path in a gradient coil for a vertical gradient field.

If the current path and the current density are known, it is possible to calculate the magnetic field disturbance in the imaging area depending on the frequency and amplitude of the floor vibrations. Since the influence of the frequency on the conductivity is slight in the case of low frequencies, the magnetic field disturbance is approximately proportional to the frequency, and for small amplitudes, such as are considered here, proportional to the amplitude of the floor vibrations. A gradient-like magnetic field disturbance essentially results from the current path shown in FIG. 5. In this case it is obvious that the compensation should be able to be effected particularly easily with the aid of a compensation current in the corresponding gradient coil. This does not necessarily need to hold true, however, for basic field magnets of other forms.

The magnetic field at a location within the field coils is normally described by the coefficients A(l,m) of a spherical function expansion: If the magnetic field disturbance is also described in a spherical function expansion, the required currents can be calculated by the field coils which compensate in the best possible manner individually or jointly for the magnetic field disturbance.

With regard to the control of the field coils, for compensation purposes it must be possible for the currents to be set with a high degree of precision by the field coils. The control of an MR device with a word size of approximately 20 bits enables compensation according to the invention of the magnetic field disturbances, given a sensitivity of the linear field coils of 90 μT/A/m. Higher-order field coils, shim coils for example, achieve approximately the same field amplitude precision for control purposes as a result of their lower sensitivity of approximately 10 μT/A/m even given a smaller word size.

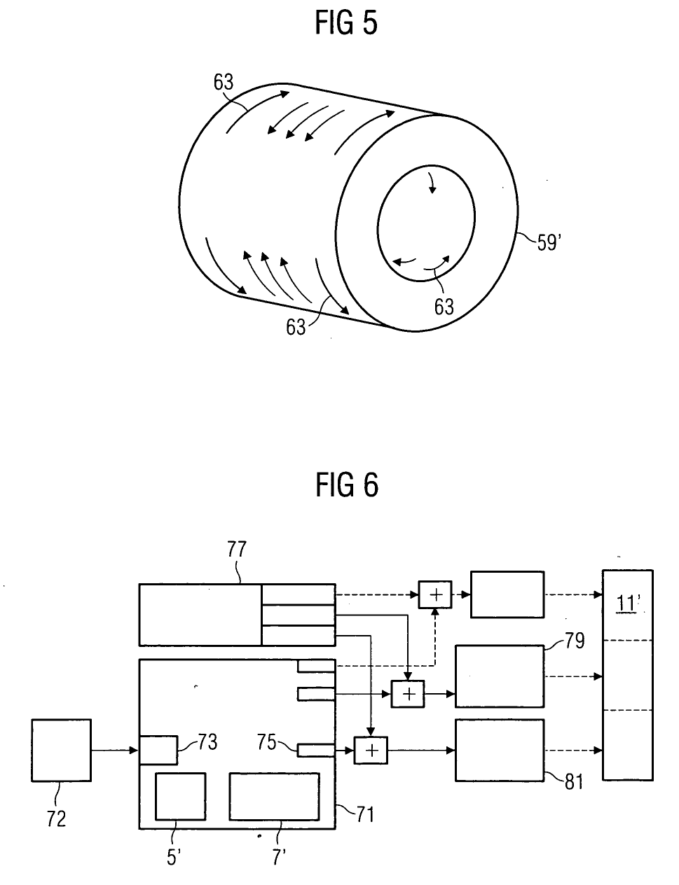

A block diagram in FIG. 6 shows a simple implementation by way of example of compensation with the aid of an add-on system. The add-on system consists of a rapid prototyping system 71 (industry PC with a DSB [sic] card) which carries out processing of data from the sensors 72 and the calculation of the mechanical model 5′ as well as the magnetic field disturbance calculation 7′, and thus serves as the control unit for compensation purposes. Accordingly, it has A/D converters 7 which record the sensor data and D/A converters which output the calculated control currents (D/A converters 75). The control currents have the currents (high gradient currents, for example) output by an MR controller 77 superimposed on them and are fed to the different amplifier units, for example the gradient amplifier 79 or a shim amplifier 81. The amplifiers are connected to the associated field coils 11′.

The time characteristic of the compensation currents can be approximated, for example with the aid of a multistage exponential filter. Such filter banks can be implemented in a simple manner in digital form with the aid of the rapid prototyping system 71. The addition of the compensation currents and the control currents for the MR control unit 77 can for example be implemented by means of an analog circuit which picks off the analog desired current values of the amplifier circuits.

1.-22. (canceled)

23. A method of compensating for a magnetic field disturbance of a magnetic field affecting a magnetic resonance device, the magnetic field disturbance caused by a deflection of a component of the magnetic resonance device, the method comprising:
acquiring the deflection or a variable causing the deflection relative to a time scale;
determining a mathematical field disturbance model describing an effect of the deflection on the magnetic field;
determining a control variable by processing the acquired deflection respectively the variable causing the deflection using the field disturbance model; and
feeding the control variable to a field generator for compensating for the magnetic field disturbance.

24. The method according to claim 23, wherein the field generator is a compensation magnetic field generator, and a compensation magnetic field compensating for the magnetic field disturbance is generated by the compensation magnetic field generator based on the control variable.

25. The method according to claim 23, wherein the field generator is a high-frequency antenna of the magnetic resonance device, and a mid frequency of the high-frequency antenna is set based on the control variable, the mid frequency matched to the magnetic field disturbance.

26. The method according to claim 23, wherein the magnetic field disturbance is caused in an imaging area of the magnetic resonance device.

27. The method according to claim 23, wherein the component is a cold shield of a basic field magnet of the magnetic resonance device.

28. The method according to claim 27, wherein the cold shield is deflected as a result of a floor vibration relative to a basic magnetic field coil of the basic field magnet.

29. The method according to claim 23, wherein the deflection of the component is measured using a strain gage.

30. The method according to claim 23, wherein the deflection is measured using an accelerometer sensor.

31. The method according to claim 23, wherein the field disturbance model includes a mechanical model of the magnetic resonance device.

32. The method according to claim 31, wherein the mechanical model includes a mechanical fixing of the component in the magnetic resonance device.

33. The method according to claim 24, wherein the field disturbance model includes a spatial characteristic of the compensation magnetic field.

34. The method according to claim 23, wherein the field disturbance model includes a relationship between the variable causing the deflection and the deflection.

35. The method according to claim 24, wherein the compensation magnetic field generator is a compensation magnetic field generator selected from the group consisting of a basic magnetic field coil, a gradient coil and a higher order shim coil, wherein the compensation magnetic field generator generates at least part of the compensation magnetic field when fed with a compensation current.

36. The method according to claim 25, wherein the mid frequency is set using a synthesizer fed with the control variable.

37. A magnetic resonance device, comprising:
a component which can be spatially deflected, a deflection of the component causing a disturbance in a magnetic field of the magnetic resonance device;
an acquisition unit for acquiring the deflection or for acquiring a variable causing the deflection, relative to a time scale; and
a control unit comprising a mathematical field disturbance model for feeding the acquired deflection or the variable causing the deflection to the mathematical field disturbance model, the mathematical field disturbance model describing an effect of the deflection on the magnetic field, and for determining a control variable for operating the magnetic resonance device such that the magnetic field disturbance is compensated for using the control variable.

38. The magnetic resonance device according to claim 37, further comprising a high-frequency antenna unit, a mid frequency of the high-frequency antenna unit matched to the magnetic field disturbance using to the control variable.

39. The magnetic resonance device according to claim 37, further comprising a compensation magnetic field generator for generating a compensation magnetic field based on the control variable, the compensation magnetic field compensating for the magnetic field disturbance.

40. The magnetic resonance device according to claim 37, wherein the component is a cold shield of a basic field magnet of the magnetic resonance device.

41. The magnetic resonance device according to claim 40, wherein the cold shield is deflected as a result of a floor vibration relative to a basic magnetic field coil of the basic field magnet.

42. The magnetic resonance device according to claim 37, further comprising a strain gage for measuring the deflection of the component, the strain gage arranged between the component and a mounting support of the component.

43. The magnetic resonance device according to claim 37, further comprising an accelerometer for measuring a floor vibration arranged on a floor in an area adjacent to the magnetic resonance device, wherein the magnetic resonance device is installed on the floor.

44. The magnetic resonance device according to claim 37, wherein the field disturbance model comprises a mechanical model of the magnetic resonance device.

45. The magnetic resonance device according to claim 44, wherein the mechanical model includes a mechanical fixing of the component in the magnetic resonance device.

46. The magnetic resonance device according to claim 37, wherein the field disturbance model includes a relationship between the variable causing the deflection and the deflection.

47. The Magnetic resonance device according to claim 37,
wherein the field disturbance model includes a model for compensating the magnetic field for the disturbance in the magnetic field.

48. The magnetic resonance device according to claim 39, wherein the compensation magnetic field generator is a compensation magnetic field generator selected from the group consisting of a basic magnetic field coil, a gradient coil and a higher order shim coil, and the control variable is a compensation current fed to the compensation magnetic field generator, the compensation current generating at least part of the compensation magnetic field when fed to the compensation magnetic field generator.
